(19) United States
(12) Patent Application Publication
(10) Pub. No.: US 2005/0267796 A1
(43) Pub. Date: Dec. 1, 2005

(54) Business method for optimizing product design, development and manufacture

(76) Inventors: Joe Ficalora, Manalapan, NJ (US); Ian Wedgwood, New Braunfels, TX (US)

Correspondence Address: Arthur M. Peslak, Esq.;MANDEL & PESLAK, LLC, 80 Scenic Drive, Suite 5, Freehold, NJ, 07728, US

(21) Appl. No.: 10/856,900

(22) Filed: May 28, 2004

(51) Int. Cl. G06F 17/60

(52) U.S. Cl. 705/11

(57) ABSTRACT

A method for optimizing the design, development and manufacture of a new product or process is disclosed. The method comprises an optimal order for various steps to be taken to ensure that robust products and services are created.

### BACKGROUND OF THE INVENTION

The present invention is directed to a method for optimizing the process for design, development, and manufacture of a new product or service. A well-known available product development process is the 6-sigma method. The present invention is directed to a method that improves upon the results that can be achieved through the 6-sigma method.

### SUMMARY OF THE INVENTION

The present invention is directed to a new business method for optimizing the process for design and development of a new product or service. By utilizing the steps in the method of the present invention in an optimal order, a user will be able to create new products or services with a higher perceived customer value than other methods and in a shorter overall time period. The primary object of the present invention is to create robust products and services in a minimum amount of time.

### BRIEF DESCRIPTION OF THE DRAWINGS

FIG. 1 illustrates the overall process steps of the method of the present invention.

FIG. 2 illustrates a sub-step of overall process steps of the present invention.

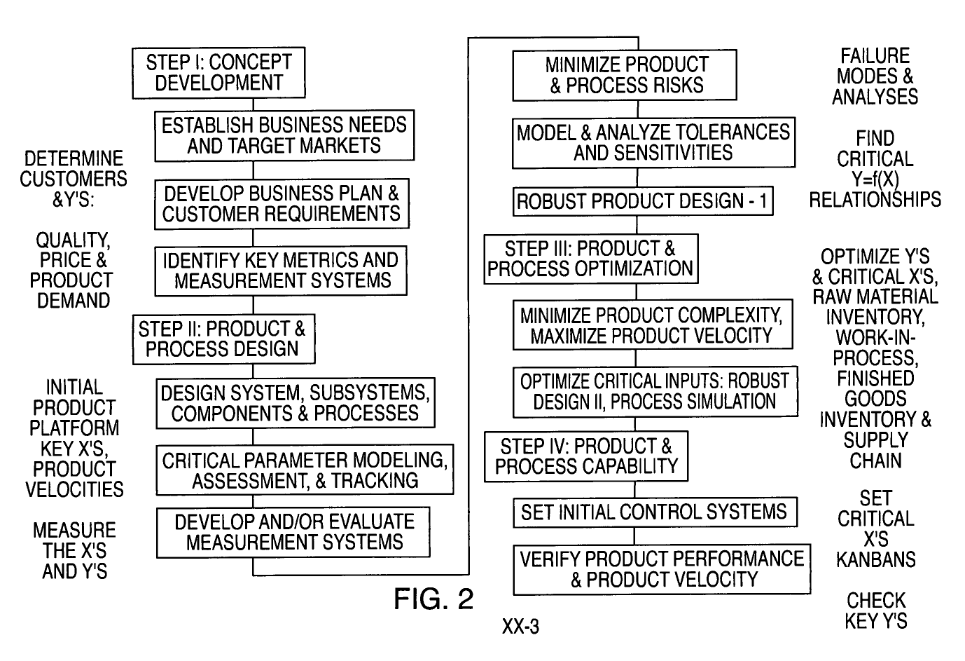

FIG. 3 illustrates a sub-step of overall process steps of the present invention.

FIG. 4 illustrates a sub-step of overall process steps of the present invention.

FIG. 5 illustrates a sub-step of overall process steps of the present invention.

FIG. 6 illustrates a sub-step of overall process steps of the present invention.

FIG. 7 illustrates a sub-step of overall process steps of the present invention.

FIG. 8 illustrates a sub-step of overall process steps of the present invention.

FIG. 9 illustrates a sub-step of overall process steps of the present invention.

FIG. 10 illustrates a sub-step of overall process steps of the present invention.

### DETAILED DESCRIPTION OF THE INVENTION

The present invention will now be described in terms of the presently preferred embodiment thereof as illustrated in the appended drawings. Those of ordinary skill in the art will recognize that many obvious modifications may be made thereto without departing from the spirit or scope of the present invention.

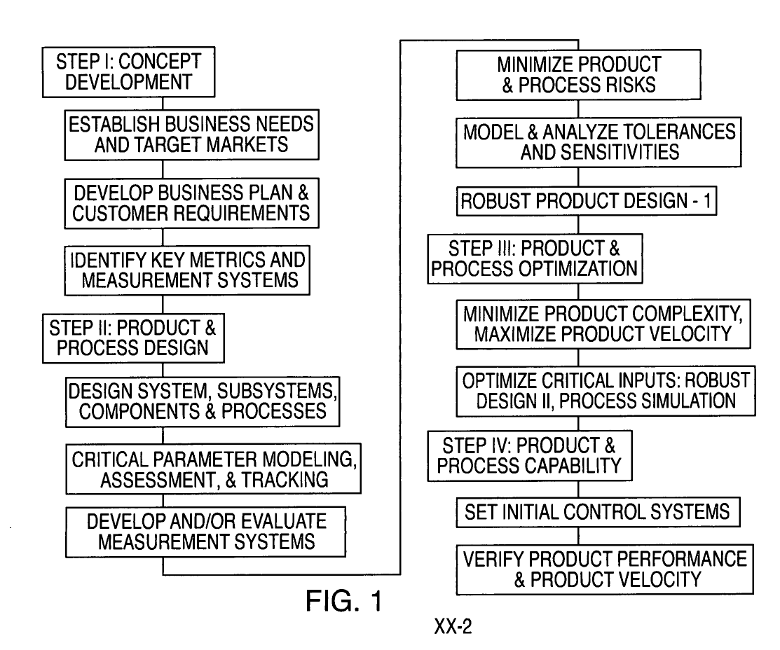

FIG. 1 illustrates the overall method steps for the present invention. Step I in the process is the conceptual development for the new product or service. Step II is the product and process design. Step III entails optimization of the product and process. Step IV is determination of the product and process capability.

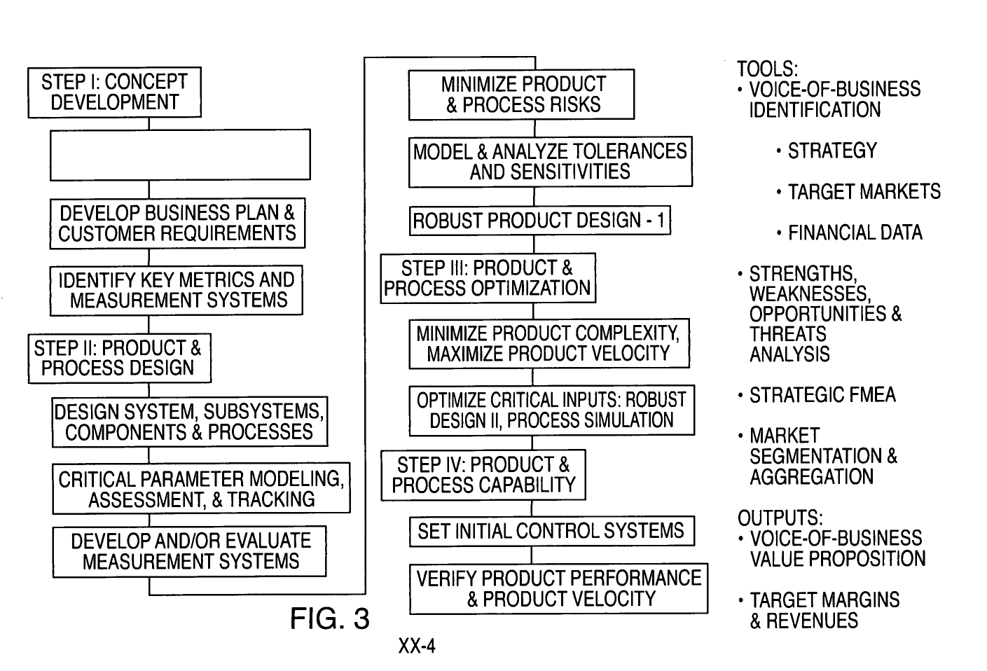

The first sub-step in Step I is to establish the business and target markets for the new product as shown in FIG. 3. The tools to be utilized during this sub-step are the voice of business identification to assess overall strategy for the new product in order to target markets for the product. Financial data relating to the product are also developed at this point. Also to be analyzed during this sub-step are the strengths and weaknesses of the proposed new product, potential opportunities for the product and potential threats to the new product. Another tool utilized during this sub-step is a strategic Failure Mode and Effects Analysis (FMEA) for the new product. FMEA determines what can fail in the product, how often it is likely to fail, the consequences of failure and how likely that the causes of any failure can be detected. Finally, market segmentation and aggregation are analyzed at this sub-step. The output of this sub-step is a voice of business value proposition for the product and target profit margins and revenues.

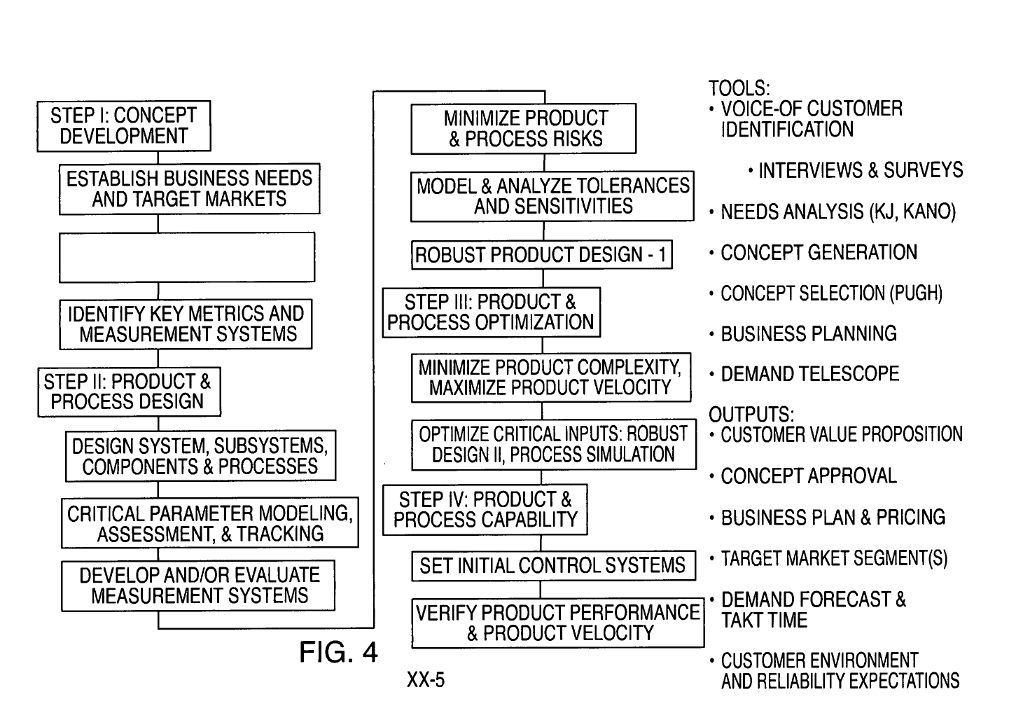

The output from the first sub-step in Step I is then used in the second sub-step to develop a Business Plan and Customer Requirements. The tools and output comprising this sub-step are illustrated in FIG. 4. The first tool utilized here is the identification of the voice of the customer through the use of interviews of individual potential customers and/or written customer surveys. A needs analysis is also utilized at this stage. From the needs analysis, concepts for the new product are generated and eventually a concept is selected using the known Pugh method. Business planning and analysis of the demand telescope are utilized at this point as well. The outputs of this sub-step comprise a customer value proposition, approval of a concept for the new product, a business plan and proposed pricing for the new product, a determination of market segments to be targeted, a forecast for product demand, the time required to produce the new product (also referred to as Takt Time), and finally the customer environment and reliability expectations for the new product.

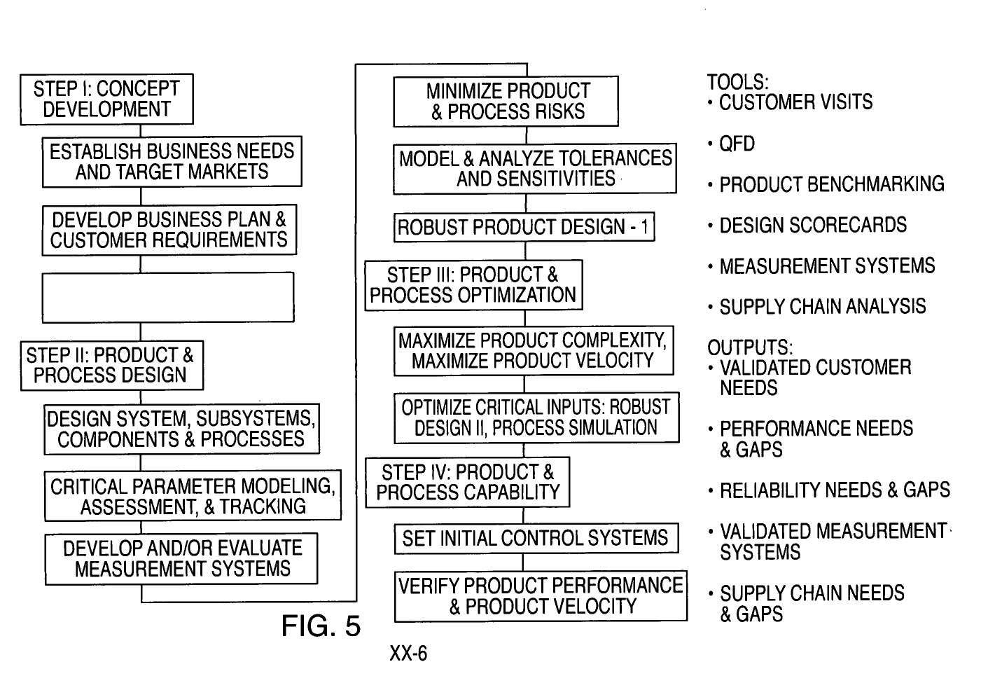

The last sub-step in Step I is to identify the key metrics and measurement systems for the subsequent design and development of the new product as illustrated in FIG. 5. The tools utilized at this sub-step comprise customer visits, Quality Function Development or QFD, product benchmarking, design scorecards, measurement systems and supply chain analysis. The outputs of this sub-step comprise validated customer needs, performance needs and gaps, reliability needs and gaps, validated measurement systems and supply chain needs and gaps.

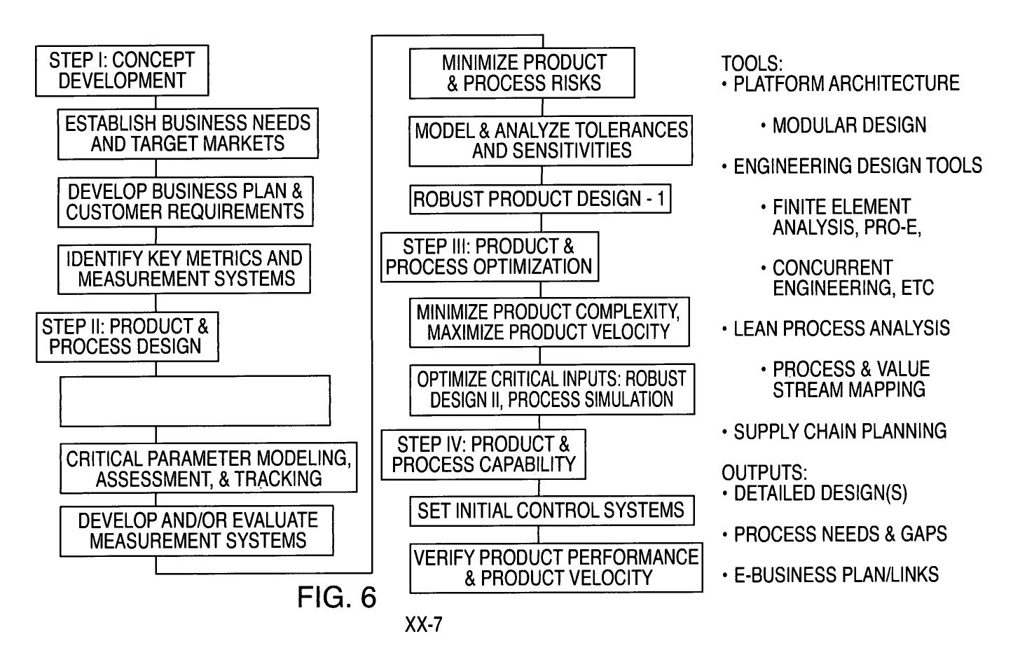

After completion of the three sub-steps of Step I, the product and process design of Step II is commenced. The first sub-step in Step II is to design the system, subsystem components and processes as illustrated in FIG. 6. The tools utilized at this sub-step comprise the platform architecture for the new product utilizing a modular design, engineering design tools such as finite element analysis, Pro-E and concurrent engineering, lean process analysis including process and value stream mapping and supply chain planning. The outputs from this sub-step are the detailed design of the new product, process needs and gaps and e-business plans/links.

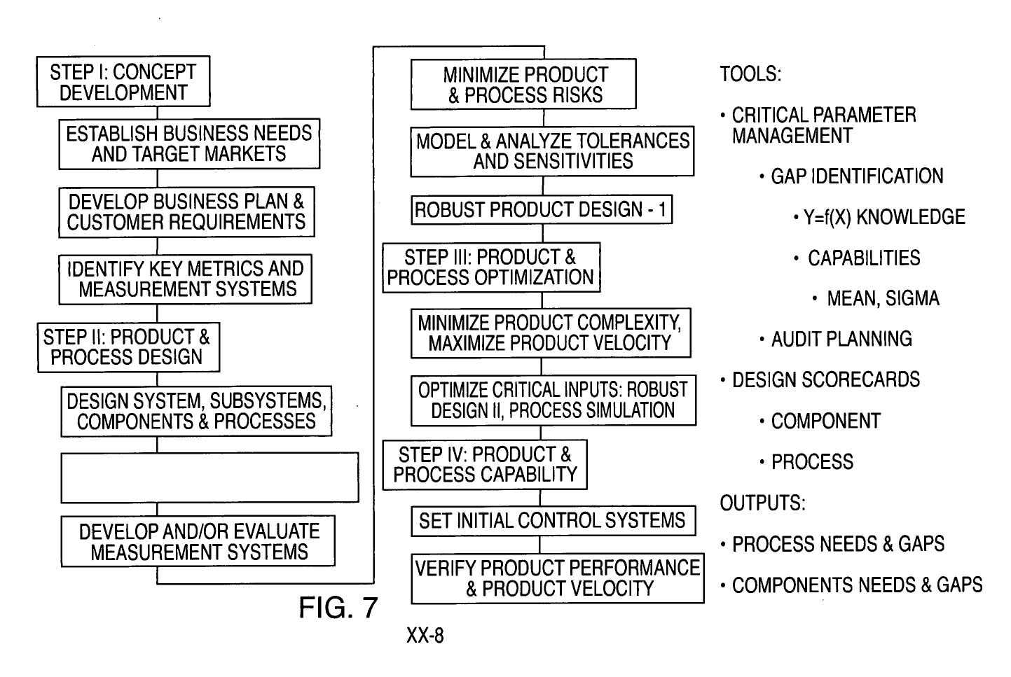

The second sub-step in Step II is critical parameter modeling, assessment and tracking as illustrated in FIG. 7. The tools utilized at this sub-step comprise critical parameter management, which includes gap identification, y=f(x) knowledge, mean and sigma capabilities, and audit planning. Another tool utilized at this step is design score cards for the components and processes. The output from this sub-step comprises process needs and gaps and component needs and gaps.

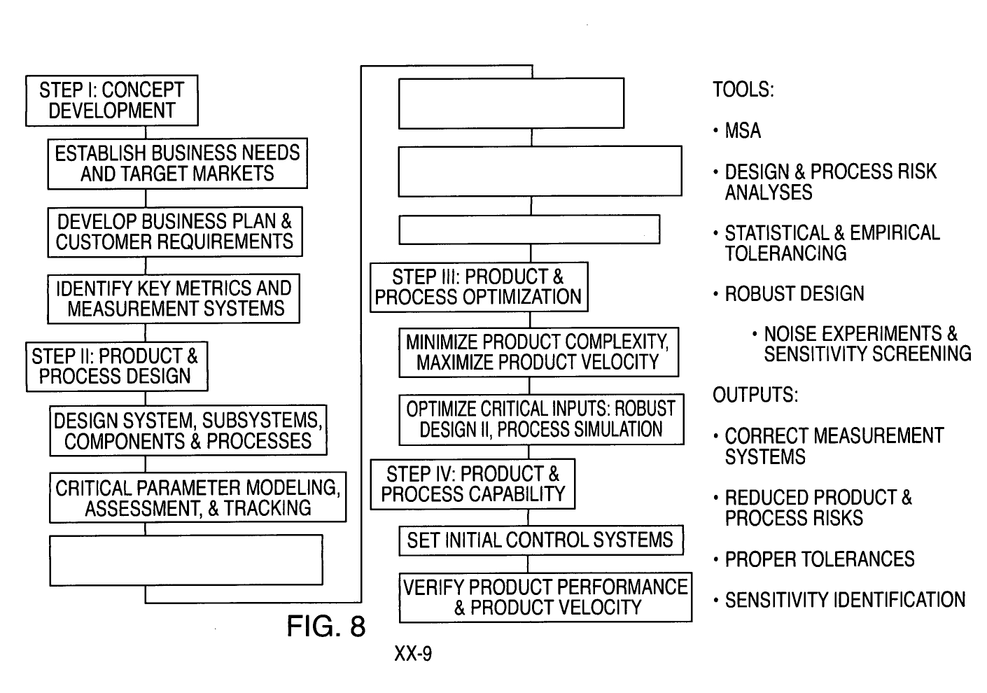

The third sub-step in Step II is to develop and/or evaluate measurement systems as illustrated in FIG. 8. The tools utilized at this sub-step comprise MSA[?], design and process risk analysis, statistical and pinnacle tolerances, and robust design. The outputs from this sub-step comprise correct measurement systems, reduced product and process risks, proper tolerances, and sensitivity identification.

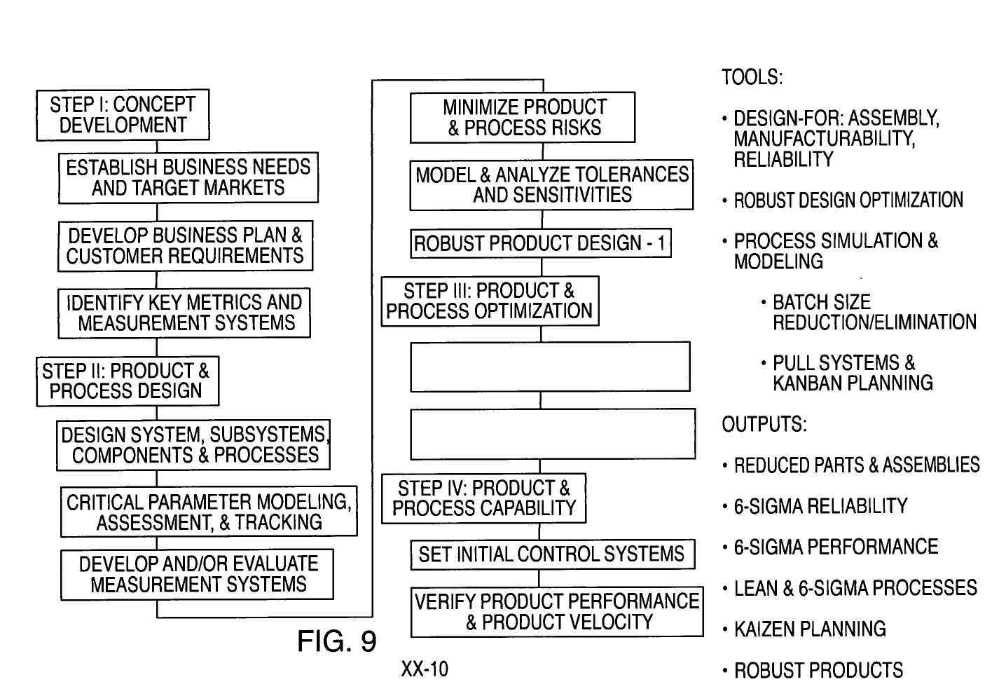

Step III of the process is the optimization of the product and process as illustrated in FIG. 9. The tools utilized at this step comprise designing of the new product for assembly, manufacturability and reliability, robust design optimization, and process simulation and modeling which includes pull systems and kanban planning. The outputs at this step are reduced parts and assemblies, 6-sigma reliability, 6-sigma performance, lean & 6-sigma processes, kaizen planning and robust new products.

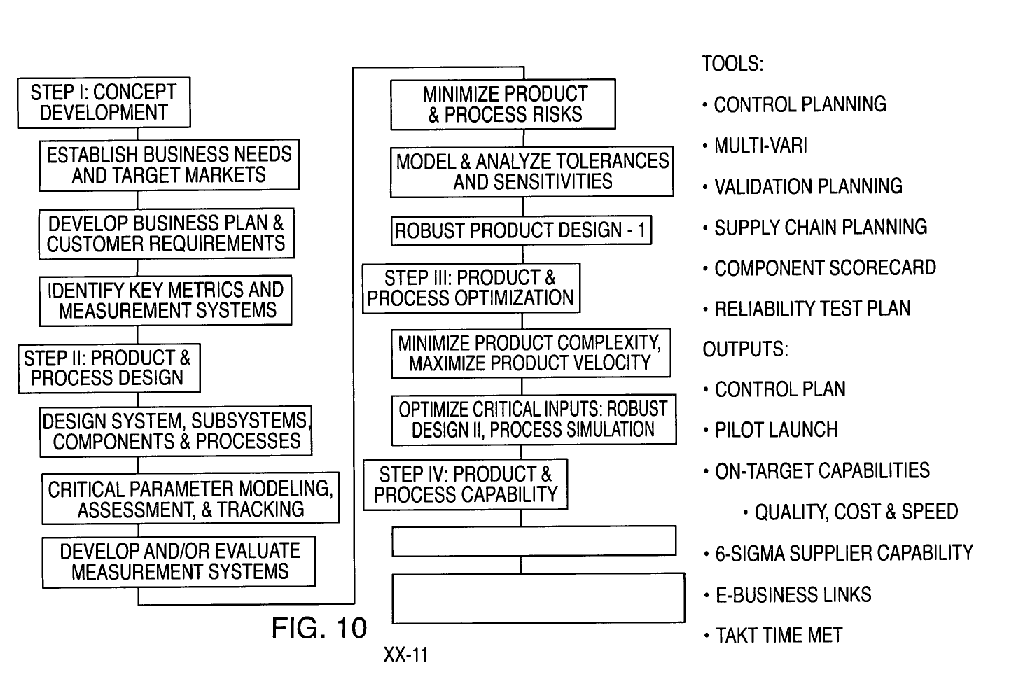

The final step in the process of the present invention is product and process capability as illustrated in FIG. 10. At this step, the tools utilized comprise control planning, multi-vari, validation planning, supply chain planning, component score cards and a reliability test plan. At this step, the final outputs from the method comprise a control plan for the new product, a pilot launch of the product, on-target capabilities, 6-sigma supplier capability, e-business links and meeting takt time.

The method of the present invention should use the tools described above sequentially in the order described above. This particular sequence of steps is the currently preferred order to obtain optimal results. By utilizing this sequence of steps in this order, the participants will be able to reduce and ultimately remove waste in a new product or new service introduction.

It is also presently contemplated that z-scoring will be used in this process. As is well known to those of ordinary skill in the art, z-scoring allows the user to track improvements as the development process proceeds. Consequently, by tracking the score of the design over the development time line, improvement over existing products and services is measured.

Those of ordinary skill in the art will recognize that the foregoing description merely illustrates an embodiment of the present invention and many modifications may be made thereto without departing from the spirit or scope of the present invention as set forth in the following claims.

1) A method for designing, developing and manufacturing a new product or service, resulting in robust product or service design, comprising the steps of:
a. Conceptual development for the new product or service in which business needs and target markets are established, business plans and customer requirements are developed and key metrics and measurement systems are identified;
b. Product and process design comprising design of system, sub-system components and process, critical parametric modeling assessment and tracking, developing and evaluating measurement systems, minimizing product and process risks, modeling and analyzing tolerances and sensitivity and a first step of robust product design;
c. Product and process optimization comprising minimizing product complexity and maximizing product velocity, optimizing critical inputs, a second step of robust product design and process simultation;
d. Utilizing z-scoring in the method to track improvements during the method; and
e. Product and process capability comprising setting individual control systems and verifying product performance and product velocity.
